(19) United States
(12) Patent Application Publication
(10) Pub. No.: US 2015/0342144 A1
(43) Pub. Date: Dec. 3, 2015

(54) ANIMAL FOOD AND PRODUCTS DISPENSER

(71) Applicants: Jacob Matthew Palmatier, York, PA (US); Christina Blaire Palmatier, York, PA (US)

(72) Inventors: Jacob Matthew Palmatier, York, PA (US); Christina Blaire Palmatier, York, PA (US)

(21) Appl. No.: 14/290,923

(22) Filed: May 29, 2014

(51) Int. Cl. A01K 5/02

(52) U.S. Cl. CPC A01K 5/0291

(57) ABSTRACT

An automatic animal food and product dispenser is provided for feeding animals a predetermined quantity of animal products (i.e. wet food, dry food, treats, toys, medicine and/or beverages) at a set time or owner-regulated intervals while the owner is absent or otherwise unavailable. The dispenser is comprised of a housing unit, a segmented dispensation cartridge which ejects incrementally at each feeding, a control system, and a power source. A control system is provided that initiates programmed feeding schedules; it determines when the dispensation cartridge is ejected so that the animal may have access to the food and/or products provided in each segment.

### BACKGROUND OF THE INVENTION

When animal owners need to leave for extended periods or they are unable to feed their animal(s) at regular intervals, they often rely on automatic feeders to provide their animal(s) with sustenance while they're away. Many animals require controlled portions of wet food, dry food or a combination of both wet and dry food in their diet. In addition many animals require medication.

Current carousel-style designs (U.S. Pat. No. 6,766,766 & U.S. Pat. No 7,650,855) have attempted to solve this issue by allowing owners to prefill single servings of food into a tray that is revealed when rotated. These related art devices present a possible pinch/crush hazard to the animals when the tray rotates. Additionally the tray is difficult to remove, clean and fill. The odd shape of the tray is often difficult and/or uncomfortable for the animal to use.

An additional drawer design exists (U.S. Pat. No. 7,051,675) which consists of three drawers that open individually, dispensing two bowls at a time at each feeding (for a maximum of three feedings total). The drawback of this related art design is that it dispenses a very limited number of feedings and features a bulky profile.

These designs can be improved upon in order to make the apparatus more user and animal friendly.

### BRIEF SUMMARY OF THE INVENTION

An object of this invention is to dispense animal products at owner-regulated time intervals. The animal products may include, but are not limited to, wet food, dry food, treats, toys, medicine and beverages. The device of the present invention utilizes a dispensation cartridge which is segmented and prefilled by the owner with the desired animal products. The cartridge is ejected from a housing unit incrementally to expose each segment at a set time or at a time interval predetermined by the animal's owner. In some embodiments, the cartridge may contain removable bowls in each segment that may or may not lock into place.

### BRIEF DESCRIPTION OF THE DRAWINGS

FIG. 1. FIG. 1 shows a perspective view of an example of an automatic animal feeder according to various embodiments described herein.

FIG. 2. FIG. 2 illustrates a perspective view in cross section showing an example of the device according to various embodiments described herein.

FIG. 3. FIG. 3 presents a perspective view of an example of a cartridge according to various embodiments described herein. In this example, the cartridge is divided into four segments.

FIG. 4. FIG. 4 provides a view of one example of a motive system for the pet feeder.

### DETAILED DESCRIPTION AND BEST MODE OF IMPLEMENTATION

In preferred embodiments the animal food and product dispenser device (the “device”) comprises the following systems: the support system, the control and power system, and the motive system. Some embodiments may also include additional features such as a cooling system, a heating system, voice recording & playback, web connectivity, video capturing, and/or an animal identification system. These systems provide the basic functions of the device and are made up of a set of individual components that may vary between different embodiments of the device. The support system provides the physical structure that supports all of the components. The control system provides information to the user and allows the user to program the device. The power system provides power to the control system, the motive system, and in some embodiments, the cooling system, the heating system, voice recording & playback, web connectivity, video capturing, and/or an animal identification system .The cooling system removes heat from the animal products and provides a thermally insulating boundary.

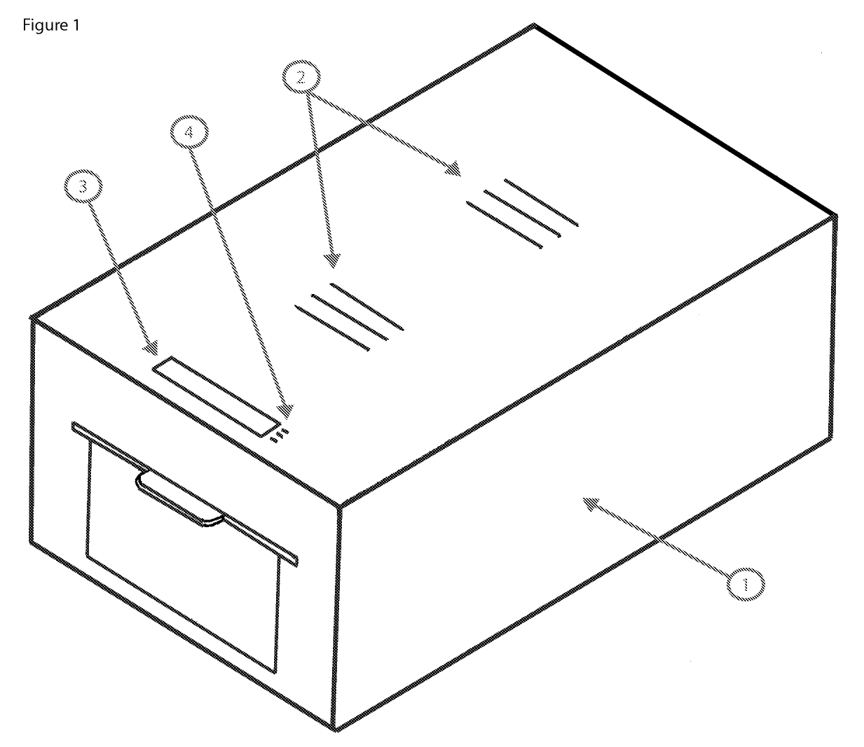

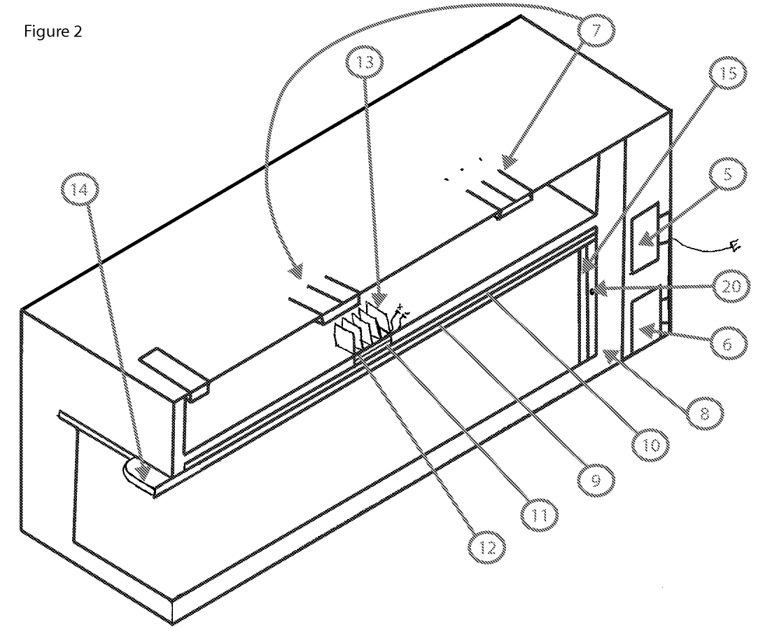

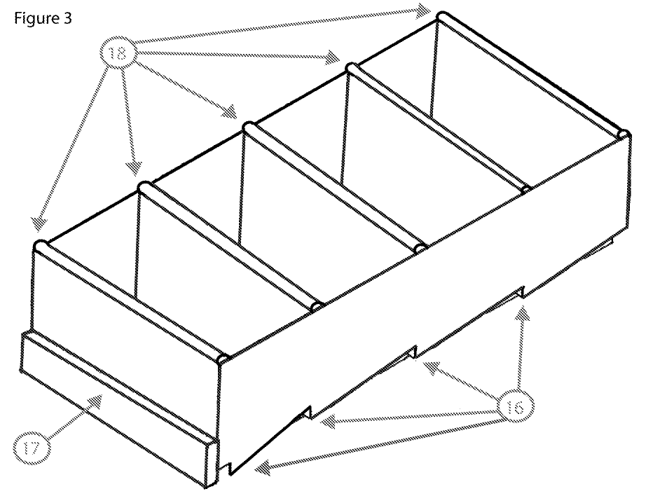

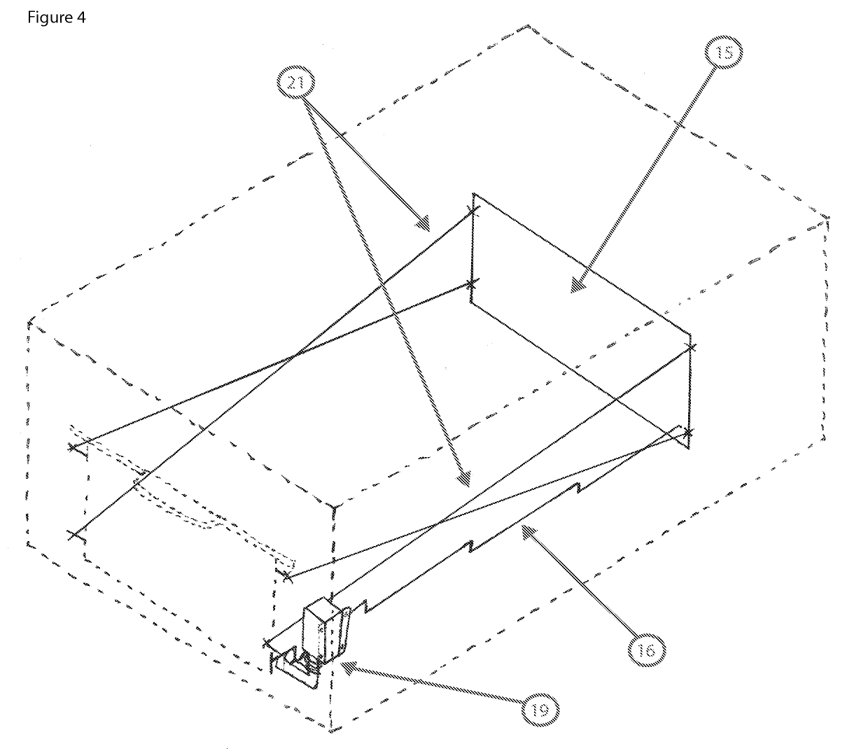

FIGS. 1 through 3 illustrate the individual components of the preferred embodiments of the invention. The feeder or device (FIGS. 1 and 2) consists generally of a housing unit 1, vents 2, display 3, input system 4, power supply and conversion unit 5, control electronics 6. In some embodiments, the device may further comprise, fans 7, insulation 8, removable thermally conductive plate 9, fixed thermally conductive plate 10, thermally conductive spacer 11, thermoelectric cooler 12, heat exchanger 13, insulating end cap 14, push plate 15. A removable tray (FIG. 3) with a ratchet edge 16, an insulating end cover 17 and tray walls 18 which may be constructed of insulated material. Items shown in FIG. 4 include a solenoid actuator and spring mechanism 19, a thermocouple 20, and an elastic tray mover 21.

The support system consists of the housing unit 1. The housing unit 1 may be of any material and design rigid and strong enough to support the internal components and the forces exerted by the elastic tray mover 21, and solenoid actuator and spring mechanism 19. For example, the housing unit 1 may be constructed from metal, plastic, wood, or any suitable material. The housing unit 1 must also have an opening for the tray (FIG. 3), and a slit for the removable thermally conductive plate 9 and insulated end cap 14. The housing unit 1 may further comprise of vents 2, and a hole or opening for a power cord.

The control and power system consists essentially of the display 3, input system 4, power supply and conversion unit 5, control electronics 6 and the thermocouple 20. The display 3 and input system 4 provide information to the user and allow the user to program the control electronics 6. The power supply and conversion unit 5 accepts power from a wall socket and converts it to the correct current type (AC vs. DC) and voltage for the control electronics 6, the display 3, the input system 4, the solenoid actuator and spring mechanism 19, the thermoelectric cooler 12 and the fans 7. The control electronics 6 accept the power from the power supply and conversion unit 5 uses it to power itself and directs the flow of power to the display 3, the input system 4, the solenoid actuator and spring mechanism 19, the thermoelectric cooler 12 and the fans 7. The thermocouple 20 provides a voltage signal to the control electronics 6 which may convert this signal into a corresponding temperature, compare this to a temperature specified by the user and provides power to the thermoelectric cooler 12 and the fans 7 as needed to maintain the specified temperature. The control electronics 6 maintains an internal time that may be adjusted by the user through the input system 4. The control electronics 6 provide time feedback to the display, compares the time to set times specified by the user and activates the solenoid actuator and spring mechanism 19 when the specified time equals the set time.

The motive system for this particular embodiment consists of the push plate 15, the ratchet edge 16, the solenoid actuator and spring mechanism 19 and the elastic tray mover 21. The elastic tray mover 21 is attached to the push plate 15. When the user loads the tray into the animal feeder, it contacts and pushes on the push plate 15, the elastic tray mover 21 is extended, and the solenoid actuator and spring mechanism 19 catches on the first notch of the ratchet edge 16, holding the tray in place. When the solenoid actuator and spring mechanism 19 receives a signal from the control electronics 6, the solenoid moves the mechanism out of the first notch on the ratchet edge 16. This allows push plate 15 and the elastic tray mover 21 to push the tray to the next notch on the ratchet edge 16. Subsequent signals from the control electronics 6 repeat this process until the tray is fully expelled from the animal feeder.

In some preferred embodiments, the device may comprise a cooling system. The cooling system consists essentially of the vents 2, the fans 7, the heat exchanger 13, the thermoelectric cooler 12, the thermally conductive spacer 11, the fixed thermally conductive plate 10, the removable thermally conductive plate 9, the insulating end cap 14, and the insulation 8. The vents 2 allow the fans 7 to adequately provide forced air circulation to the heat exchanger 13 which rejects heat from the thermoelectric cooler 12. The thermoelectric accepts power from the power system, heats the heat exchanger 13 and cools the fixed thermally conductive plate 10, which then cools the removable thermally conductive plate 9. The removable thermally conductive plate 9 is exposed to the animal products in the tray and may become soiled, necessitating its removal for cleaning The insulating end cap 14 keeps the cold surface of the removable thermally conductive plate 9 from contacting the outside air, and maintains a thermal barrier in conjunction with the insulation 8. The insulation 8, covers the stationary thermally conductive plate 10, the sides and bottom of the housing unit 1, the area behind the push plate 15, and the front of the housing unit 1. Additional insulation is necessary on the removable tray, in the form of an insulating end cover 17 and insulating tray walls 18. This insulation provides the thermal boundary to keep the animal products cool. The insulating end cover 17 also provides a surface that slides along the floor and keeps the tray horizontal as it is pushed from the animal feeder.

As shown by FIG. 3, a cartridge is divided into a plurality of segments by tray walls 18. In some preferred embodiments, tray walls 18 may be insulated. The tray is configured with ratchet edge 16 or other means allowing each segment to be ejected out of the device providing an animal access to that segment and its contents.

### SUMMARY OF A PREFERRED EMBODIMENT

1. An automatic animal product dispenser apparatus comprising:

A housing consisting of a top wall, a bottom wall, a front peripheral wall and a back wall. The front peripheral wall has one or more openings in which a single or plurality of food delivery assemblies are positioned into.

A dispensation cartridge that slides into position in the opening.

A motive mechanism for the dispensation cartridge(s).

A control mechanism to control the dispensation of products and to control other optional features.

What is claimed is:

1. An automatic animal product dispenser apparatus comprising:
A housing consisting of a top wall, a bottom wall, a front peripheral wall and a back wall. The front peripheral wall has one or more openings in which a single or plurality of food delivery assemblies are positioned into. A dispensation cartridge that slides into position in the opening. A motive mechanism for the dispensation cartridge(s). A control mechanism to control the dispensation of products and to control other optional features.

2. The automatic animal product dispenser of claim 1 in which multiple dispensation cartridges slide into one or more openings.

3. The automatic animal product dispenser of claim 1 in which the dispensation cartridge(s) are covered with a membrane that peels away.

4. The automatic animal product dispenser of claim 1 in which the dispensation cartridge(s) are disposable.

5. The automatic animal product dispenser of claim 1 in which the dispensation cartridge(s) are pre-filled with pet products for purchase by the user.

6. The automatic animal product dispenser of claim 1 in which some or all of the space inside the housing is chilled with a cooling device.

7. The automatic animal product dispenser of claim 1 in which the housing allows access to the parts inside.

8. The automatic animal product dispenser of claim 1 in which the control mechanism is programmable by the user.

9. The automatic animal product dispenser of claim 1 in which the control mechanism is not programmable by the user.
